(19) United States
(12) Patent Application Publication
(10) Pub. No.: US 2009/0225035 A1
(43) Pub. Date: Sep. 10, 2009

(54) APPARATUS AND METHOD FOR INPUTTING KEY IN TERMINAL HAVING TOUCH SCREEN

(75) Inventor: Jong-Min BAIK, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 11/871,674

(22) Filed: Oct. 12, 2007

(30) Foreign Application Priority Data
Oct. 25, 2006 (KR) 2006-0103830

(51) Int. Cl. G06F 3/041

(52) U.S. Cl. 345/173

(57) ABSTRACT

Provided are an apparatus and a method for inputting a key in a terminal having a touch screen. The apparatus includes a display; a touch sensor positioned above the display to sense a touch; and a controller for overlapping a semitransparent keyboard on one of a background and executed application screens output on the display when a key input event occurs, checking whether the touch is for a key input, if the touch is for the key input, receiving a key in a position corresponding to the touch, and outputting the key to the display.

### PRIORITY

This application claims priority under 35 U.S.C. § 119 to an application filed in the Korean Intellectual Property Office on Oct. 25, 2006 and assigned Serial No. 2006-103830, the contents of which are incorporated herein by reference.

### BACKGROUND OF THE INVENTION

1. Field of the Invention

The present invention relates generally to an apparatus and a method for inputting a key in a terminal having a touch screen, and in particular, to an apparatus and a method for overlapping a semitransparent keyboard on a background output on a touch screen and inputting a key using the semitransparent keyboard.

2. Description of the Related Art

Portable terminals such as mobile communication terminals or Personal Digital Assistants (PDAS) have been widely used. Such a portable terminal is used to manage simple telephone calls, schedules, etc, photograph images or moving pictures through a digital camera installed therein. The portable terminal is also used to view digital multimedia broadcasts, edit documents, play games, execute navigations, and transmit and receive multimedia messages including simple messages and photographed images or moving pictures. Thus, the application ranges of portable terminals have been increasingly expanded.

A large number of letters can be input through a portable terminal with increased functions of the portable terminal. For example, if Internet services are provided through a portable terminal, an Internet address or the like must be input into an address window of a web browser. Even if letter messages are written, letters must be input. The portable terminal uses a touch screen to further conveniently input keys such as letters or the like. Therefore, a user can conveniently input the keys using the portable terminal.

FIGS. 1A and 1B illustrate touch screens of a terminal outputting a keyboard according to the prior art. FIG. 1A illustrates the touch screen of the terminal outputting only a web browser without the keyboard, and FIG. 1B illustrates the touch screen simultaneously outputting the web browser and the keyboard.

The terminal having the touch screen outputs the keyboard on the touch screen as shown in FIG. 1B so as to enable keys to be input. However, as shown in FIG. 1B, the touch screen outputting a provided application becomes relatively smaller than the touch screen of FIG. 1A which does not yet output the keyboard. Thus, a user must scroll the touch screen to use the web browser.

### SUMMARY OF THE INVENTION

An aspect of the present invention is to substantially solve at least the above problems and/or disadvantages and to provide at least the advantages below. Accordingly, an aspect of the present invention is to provide an apparatus and a method for inputting a key in a terminal having a touch screen.

Another aspect of the present invention is to provide an apparatus and a method for overlapping a semitransparent keyboard on a background output on a touch screen and inputting a key using the semitransparent keyboard.

A further aspect of the present invention is to provide an apparatus and a method for overlapping a semitransparent keyboard on a background output on a touch screen and sensing touches to the semitransparent keyboard to determine a quick touch as an input of a key and a long touch as an input for a pointer.

Another further aspect of the present invention is to provide an apparatus and a method for overlapping a semitransparent keyboard on a background output on a touch screen and sensing a touch to the touch screen to determine the touch as an input of a key or an input for a pointer depending on whether an input selection key is activated.

According to one aspect of the present invention, an apparatus for inputting a key in a terminal having a touch screen is provided. The apparatus includes a display outputting one of a background screen and an executed application screen, and when a key input event occurs, overlapping a semitransparent keyboard on one of the background screen and the executed application screen; a touch sensor positioned above the display to sense a touch; and a controller for overlapping the semitransparent keyboard on one of the background and executed application screens output on the display when the key input event occurs, checking whether the touch sensed by the touch sensor is to input a key, when the touch is to input the key, receiving a key in a position corresponding to the touch, and outputting the key to the display.

According to another aspect of the present invention, a method of inputting a key in a terminal having a touch screen is provided. The method includes overlapping a semitransparent keyboard on an output screen when a key input event occurs; sensing a touch to the touch screen; checking whether the sensed touch is to input a key; and receiving and outputting the key in a position corresponding to the touch when the touch is to input the key.

### BRIEF DESCRIPTION OF THE DRAWINGS

The above and other objects, features and advantages of the present invention will become more apparent from the following detailed description when taken in conjunction with the accompanying drawings in which:

FIGS. 1A and 1B illustrate touch screens of a terminal outputting a web browser according to the prior art;

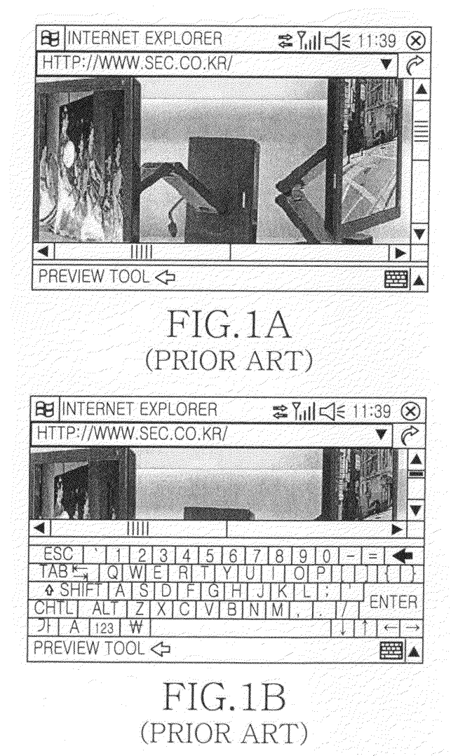

FIG. 2 is a block diagram of a terminal having a touch screen according to the present invention;

FIG. 3 is a flowchart of a method of inputting a key in a terminal having a touch screen according to the present invention;

FIG. 4 is a flowchart of a method of determining whether a key is input, depending on whether a touch to a touch screen is long or quick in a terminal having the touch screen, according to the present invention;

FIG. 5 is a flowchart of a method of determining whether a key is input, depending on whether an input selection key is activated in a terminal having a touch screen, according to the present invention; and

FIGS. 6A, 6B, and 6C illustrate touch screens outputting a keyboard in a terminal having the touch screen, according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and a method for overlapping a semitransparent keyboard on a background or application output on a touch screen and inputting a key using the semitransparent keyboard.

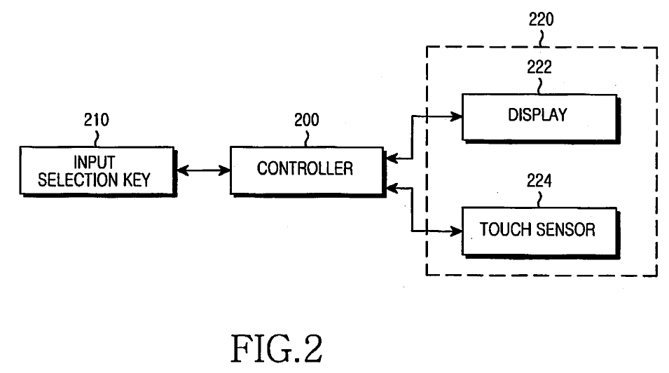

FIG. 2 is a block diagram of a terminal having a touch screen according to the present invention.

Referring to FIG. 2, the terminal according to the present preferred embodiment includes a controller 200, an input selection key 210, and a touch screen 220. The touch screen 220 includes a display 222 and a touch sensor 224.

The display 222 is controlled by the controller 200 to output a background or application, when a key input event occurs, makes a keyboard semitransparent, and overlaps the semitransparent keyboard on the background or application. The touch sensor 224 is substantially positioned above the display 222 to sense an input touch and provide the input touch to the controller 200.

The input selection key 210 is an external button necessary for determining whether the input touch sensed by the touch sensor 224 is to move and select a pointer or input a key through the semitransparent keyboard. When the input selection key 210 is pressed once using a toggling method, the input selection key 210 may be determined to be activated. When the input selection key 210 is pressed once more, the input selection key 210 may be determined to be inactivated. Alternatively, the input selection key 210 may be determined to be activated when it is not activated while it is being pressed.

When the key input event occurs, the controller 200 controls the display 222 to overlap the semitransparent keyboard on a currently output screen, and the input touch sensed by the touch sensor 224 is a key input, receive a key in a position corresponding to the input touch, and output the key. When the input touch sensed by the touch sensor 224 is not a key input, the controller 200 controls the display 222 to perform functions related to a movement and a selection of a pointer.

The controller 200 determines whether the input touch sensed by the touch sensor 224 is to input the key or move and select the pointer, depending on whether the input selection key 210 is activated. Alternatively, the controller 200 may determine whether the input touch is to input the key or move and select the pointer, depending on whether the input touch is long or quick. Here, the controller 200 determines whether a key is input, depending on whether the input touch sensed by the touch sensor 224 is long or quick, the input touch may be selected to be long or quick. However, according to the present invention, a quick touch is determined as a touch to input a key and a long touch is determined as a touch to move and select a pointer.

Methods of inputting a key in a terminal having a touch screen according to embodiments of the present invention will now be described with reference to the attached drawings.

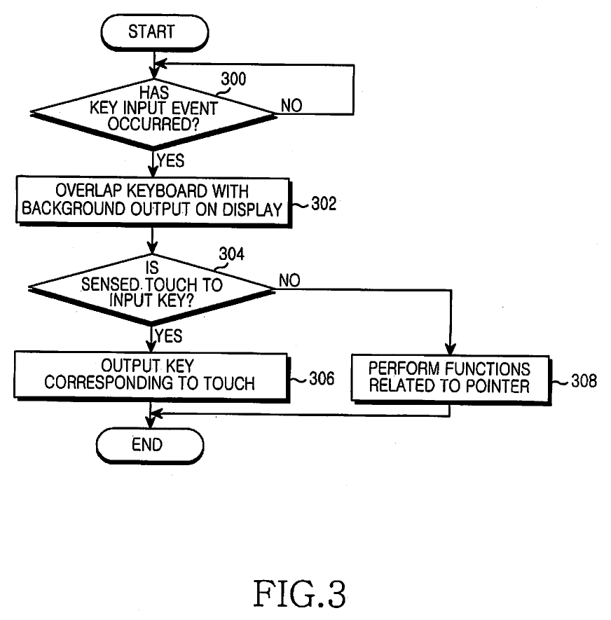

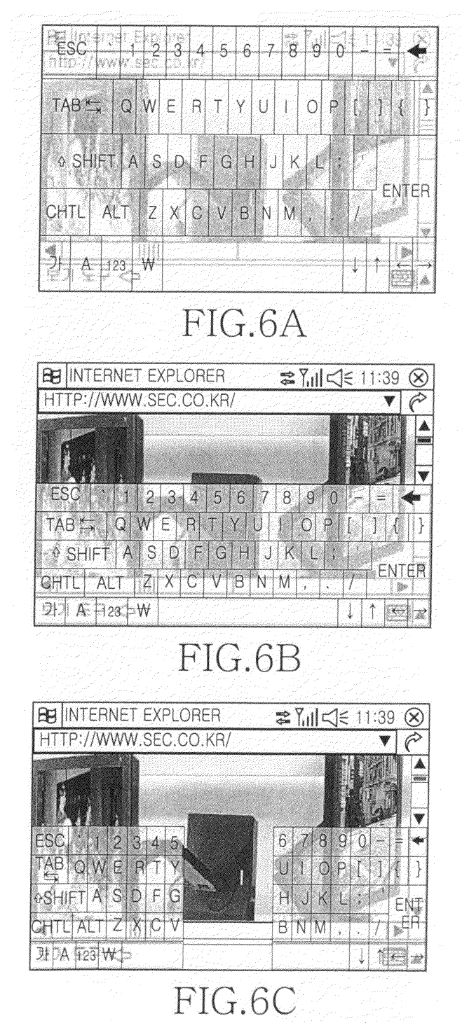

FIG. 3 is a flowchart of a method of inputting a key in a terminal having a touch screen according to the present invention. Referring to FIG. 3, in step 300, the terminal senses whether a key input event has occurred. When the key input event has occurred in step 300, the terminal proceeds to step 302 to overlap a semitransparent keyboard on a screen currently output on a display. The semitransparent keyboard overlapping the currently output screen on the display will be exemplarily described with reference to FIGS. 6A to 6C.

FIGS. 6A, 6B, and 6C illustrate a touch screen of a terminal outputting a keyboard, according to the present invention. The semitransparent keyboard may overlap an entire portion of the touch screen as shown in FIG. 6A or may overlap only a portion of the touch screen as shown in FIGS. 6B and 6C.

Back to FIG. 3, in step 304, the terminal checks whether a sensed touch is to input a key. When the sensed touch is not to input a key but to move or select a pointer in step 304, the terminal goes to step 308 to perform functions related to the movement or selection of the pointer.

When the sensed touch is to input a key in step 304, the terminal proceeds to step 306 to receive a key in a position corresponding to the sensed touch and output the key to the display 222.

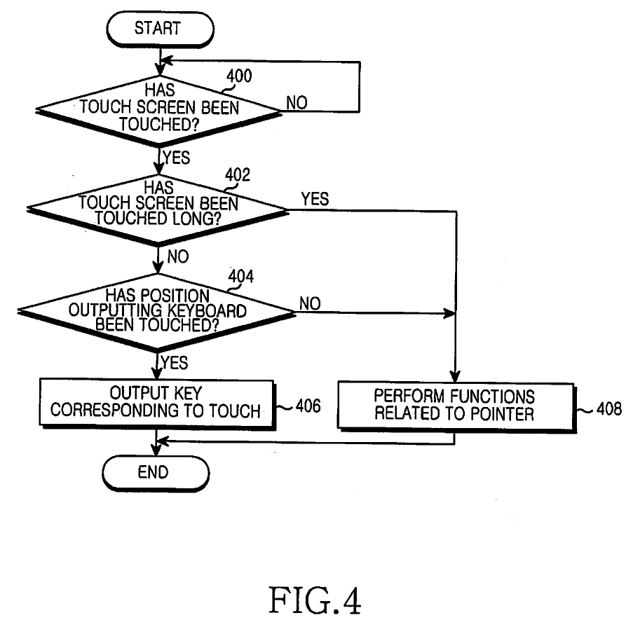

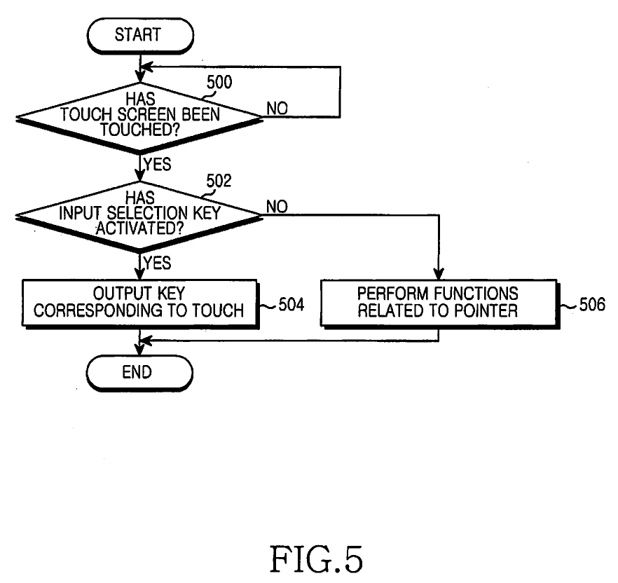

Methods of determining whether a sensed touch is a key input or to move or select a pointer will now be described with reference to FIGS. 4 and 5.

FIG. 4 is a flowchart of a method of determining whether a key is input, depending on whether a touch to a touch screen is long or quick in a terminal having the touch screen, according to the present invention. Referring to FIG. 4, in step 400, the terminal senses whether a touch screen has been touched. When the touch screen has been touched in step 400, the terminal proceeds to step 402 to check whether the touch screen has been touched long. If the touch screen has been touched long in step 402, the terminal goes to step 408 to perform functions related to a pointer, i.e., move or select the pointer.

When the touch screen has not been touched long, the terminal proceeds to step 404 to check whether a position outputting a keyboard has been touched, i.e., an output keyboard has been touched. When the output keyboard has not been touched in step 404, the terminal goes to step 408 to perform the functions related to the pointer, i.e., move or select the pointer.

When the output keyboard has been touched in step 404, the terminal proceeds to step 406 to receive a key in a position corresponding to the touch and output the key to the display 222.

FIG. 5 is a flowchart of a method of determining whether a key is input, depending on whether an input selection key is activated in a terminal having a touch screen, according to the present invention.

Referring to FIG. 5, in step 500, the terminal senses whether a touch screen has been touched. When the touch screen has been touched in step 500, the terminal proceeds to step 502 to check whether an input selection key for inputting a key has been activated. When the input selection key has been inactivated in step 502, the terminal goes to step 506 to perform functions related to a pointer, i.e., move or select the pointer.

When the input selection key has been activated in step 502, the terminal proceeds to step 504 to receive a key in a position corresponding to a touch and output the key to the display 222.

In accordance with the present invention as described above, a semitransparent keyboard can overlap a background or application output on a touch screen, and a key can be input using the semitransparent keyboard. Thus, a reduction in an area of an output screen caused by the input of the key can be avoided. As a result, a user can conveniently input a key from a keyboard screen and concurrently view a background or application output screen on the same touch screen.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for inputting a key in a terminal having a touch screen, comprising:
a display for outputting a semitransparent keyboard overlapping one of a background screen and an executed application screen;
a touch sensor positioned above the display to sense a touch; and
a controller for overlapping the semitransparent keyboard on one of the background and executed application screens output on the display when a key input event occurs, checking whether the touch is for a key input, when the touch is for the key input, receiving a key in a position corresponding to the touch, and controlling the key to be output on the display.

2. The apparatus of claim 1, wherein when the touch is for a pointer, the controller controls the pointer to correspond to the touch.

3. The apparatus of claim 2, wherein the controller determines whether the touch is for the key input or for the pointer, depending on whether the touch is long or quick.

4. The apparatus of claim 3, wherein when the touch is quick, the controller determines the touch is for the key input, and when the touch is long, the controller determines the touch is for the pointer.

5. The apparatus of claim 2, further comprising an input selection key for setting the touch for one of the key input and the pointer.

6. A method of inputting a key in a terminal having a touch screen, comprising:
overlapping a semitransparent keyboard on an output screen of one of a background and an executed application when a key input event occurs;
sensing a touch to the touch screen;
checking whether the touch is for a key input; and
when the touch is for the key input, receiving and outputting a key in a position corresponding to the touch.

7. The method of claim 6, further comprising, when the touch is for a pointer, performing a function corresponding to the pointer.

8. The method of claim 7, wherein the touch is for the key input or for the pointer depending on whether the touch is long or quick.

9. The method of claim 8, wherein when the touch is quick, the touch is for the key input, and when the touch is long, the touch is for the pointer.

10. The method of claim 7, wherein when an input selection key is activated, the touch is for the key input.

11. An apparatus for inputting a key in a portable terminal having a touch screen, comprising:
means for overlapping a semitransparent keyboard on an output screen of one of a background and an executed application when a key input event occurs;
means for sensing a touch to the touch screen; and
means for inputting a key in a position corresponding to the touch.

12. A method for inputting a key in a portable terminal having a touch screen, comprising:
overlapping a semitransparent keyboard on an output screen of one of a background and an executed application when a key input event occurs;
sensing a touch to the touch screen; and
inputting a key in a position corresponding to the touch.

13. A computer-readable recording medium having recorded thereon a program for inputting a key in a portable terminal having a touch screen, comprising:
a first code segment, for overlapping a semitransparent keyboard on an output screen of one of a background and an executed application when a key input event occurs;
a second code segment, for sensing a touch to the touch screen; and
a third code segment, for inputting a key in a position corresponding to the touch.
